(19) United States
(12) Patent Application Publication
(10) Pub. No.: US 2021/0248492 A1
(43) Pub. Date: Aug. 12, 2021

(54) Learning and Using Property Signatures for Computer Programs

(71) Applicant: Google LLC, Mountain View, CA (US)

(72) Inventors: Augustus Quadrozzi Odena, San Francisco, CA (US); Charles Aloysius Sutton, Santa Clara, CA (US)

(21) Appl. No.: 17/170,305

(22) Filed: Feb. 8, 2021

Related U.S. Application Data
(60) Provisional application No. 62/970,899, filed on Feb. 6, 2020.

(51) Int. Cl. G06N 5/04; G06N 20/00

(52) U.S. Cl. CPC G06N 5/04; G06N 20/00

(57) ABSTRACT

Generally, the present disclosure is directed to the generation and use of property signatures for computer programs. In particular, property signatures can serve as a representation for programs and program specifications meant for consumption by machine learning algorithms. Given a function with input type τin and output type τout, a property can be a function of type: (τin, τout)→Bool that (e.g., informally) describes some simple property of the function under consideration. For instance, if τin and τout are both lists of the same type, one property might ask ‘is the input list the same length as the output list?’.

### RELATED APPLICATIONS

This application claims priority to and the benefit of U.S. Provisional Patent App. No. 62/970,899. U.S. Provisional Patent App. No. 62/970,899 is hereby incorporated by reference in its entirety.

### FIELD

The present disclosure relates generally to the automated synthesis of and/or searching among computer programs. More particularly, the present disclosure relates to generation and use (e.g., as a search feature) of property signatures for computer programs.

### BACKGROUND

Program synthesis is a longstanding goal of computer science research arguably dating to the 1940s and 50s. Deep learning methods have shown promise at automatically generating programs from a small set of input-output examples. In order to deliver on this promise, it is important to represent programs and specifications in a way that supports learning.

Just as computer vision methods benefit from the inductive bias inherent to convolutional neural networks, and likewise with LSTMs for natural language and other sequence data, it stands to reason that ML techniques for computer programs will benefit from architectures with a suitable inductive bias.

In addition to the automated generation of computer programs, similar comments to the above can be made with respect to the search for or among computer programs.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for automated synthesis of computer programs. The method includes obtaining, by one or more computing devices, a respective property signature for each of a plurality of component programs, wherein the respective property signature for each of the plurality of component programs comprises a respective plurality of Boolean values respectively for a plurality of different properties, wherein, for each component program, the Boolean value for each property indicates whether input data and output data of the corresponding component program exhibits such property; receiving, by the one or more computing devices, a request for synthesis of a new computer program from the plurality of component programs; and in response to the request, automatically synthesizing, by the one or more computing devices, the new computer program from the plurality of component programs, wherein automatically synthesizing, by the one or more computing devices, the new computer program from the plurality of component programs comprises selecting, by the one or more computing devices, one or more employed programs of the plurality of component programs for inclusion in the new computer program based at least in part on the respective property signatures of the one or more employed programs.

Another example aspect of the present disclosure is directed to a computer-implemented method for characterization of computer programs. The method includes obtaining, by one or more computing devices, data describing a plurality of component programs; and generating, by the one or more computing devices, a respective property signature for each of the plurality of component programs, wherein the respective property signature for each of the plurality of component programs comprises a respective plurality of Boolean values respectively for a plurality of different properties, wherein, for each component program, the Boolean value for each property indicates whether input data and output data of the corresponding component program exhibits such property.

Another example aspect of the present disclosure is directed to a computer-implemented method to search for computer programs. The method includes receiving, by one or more computing devices, a program search query comprising one or more example input-output pairs; generating, by the one or more computing devices, a query signature for the program search query, wherein the query signature comprises a plurality of Boolean values for a plurality of different properties, wherein the Boolean value for each property indicates whether the one or more example input-output pairs exhibit such property; accessing, by the one or more computing devices, one or more databases that collectively store a respective property signature for each of a plurality of computer programs, wherein the respective property signature for each of the plurality of computer programs comprises a respective plurality of Boolean values respectively for the plurality of different properties, wherein, for each computer program, the Boolean value for each property indicates whether input data and output data of the corresponding computer program exhibits such property; and comparing, by the one or more computing devices, the query signature to at least some of the respective property signatures for the plurality of computer programs to identify and return at least one of the plurality of computer programs as a search result responsive to the program search query.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the present disclosure.

FIG. 1B depicts a block diagram of an example computing device according to example embodiments of the present disclosure.

FIG. 1C depicts a block diagram of an example computing device according to example embodiments of the present disclosure.

FIG. 2 provides a flow chart for an example computer-implemented method for automated synthesis of computer programs.

FIG. 3 depicts a flow chart of an example computer-implemented method to search for computer programs.

Reference numerals that are repeated across plural figures are intended to identify the same features in various implementations.

### DETAILED DESCRIPTION

### Overview

Generally, the present disclosure is directed to the generation and use of property signatures for computer programs. In particular, property signatures can serve as a representation for programs and program specifications meant for consumption by machine learning algorithms. Given a function with input type τin and output type τout, a property can be a function of type: (τin, τout)→Bool that (e.g., informally) describes some simple property of the function under consideration. For instance, if τin and τout are both lists of the same type, one property might ask ‘is the input list the same length as the output list?’.

Given a list of properties, each property can be evaluated for a computer program to get a list of outputs for the computer program that can be referred to as a property signature for the program. In some implementations, the property signature for a function can be estimated or predicted given only a set of input/output pairs meant to specify that function.

There are several potential applications of property signatures, including for use in automated code synthesis solutions and for searching among computer programs. As one example, it has been shown experimentally that property signatures can be used to improve a code synthesis solution over a baseline synthesizer so that it emits twice as many programs in less than one-tenth of the time.

As another example, property signatures can be used to solve the problem of ‘Semantic Program Search’, in which the goal is to search an existing database of computer programs for a program having some user-specified semantics. One example application of property signatures has been used to build a working prototype of a system for doing Semantic Program Search—a ‘Search Engine for Functions’.

The systems and methods described herein for generation of use of property signatures provide a number of technical effects and benefits. As one example, the property signatures can be used to improve the efficiency of automated code generation. In particular, by developing property signatures for component programs used to generate a new program, a code synthesis system can more easily and quickly determine whether a given component code is a good fit or solution for the current objectives of the code synthesis process. As a result, fewer iterations overall may need to be performed to synthesize a suitable set of code. As such, computing resources can be saved (e.g., both with respect to previous automated code synthesis solutions and/or the manual generation of computer program code). For example, processor usage, memory usage, and/or bandwidth usage can be reduced.

As one example technical effect, the property signatures can be used to improve the efficiency of searching for existing code from among databases of computer program code. In particular, by developing property signatures for computer programs within a database, a program search engine can be developed which can more easily and quickly identify computer programs which are relevant to a given query such as a query that specifies a number of example input-output pairs. As a result, a developer may be able to reduce the number of potential computer programs that she tests before finding the computer program that fulfills her objective(s). As such, computing resources can be saved (e.g., both with respect to previous computer program identification solutions and/or the manual generation of computer program code). For example, processor usage, memory usage, and/or bandwidth usage can be reduced.

The systems and methods described herein can be used in many different environments and contexts, including, as examples, in an integrated development environment, database tool, code optimizer, or other settings. The systems and methods described herein can be implemented in and/or provided as part of a web-service and/or cloud-based platform. Some example implementations of the present disclosure can be implemented in part or otherwise facilitated using one or more graphical user interfaces (GUI). For example, a GUI can allow a user to search for or synthesize a replacement function or program for an existing function or program.

In one example, a user can supply an existing function and a computing system can generate example input-output pairs from existing function. For example, random and/or pre-defined inputs can be provided to the user-supplied existing function to generate outputs which can be paired within the inputs to make example input-output pairs, which can be used for example as a query and/or seed for program synthesis. In some examples, computer programs can be database queries. The database queries can have example inputs and database query outputs associated therewith. In another example, the property signatures described herein can be used as input for a compiler or for a process for selecting a compiler from among several available compilers.

Thus, the present disclosure introduces a new representation for programs and their specifications, based on the principle that to represent a program, a set of simpler programs can be used. This leads us to introduce the concept of a property, which can include or be evaluated with a program that computes a boolean function of the input and output of another program. For example, consider the problem of synthesizing a program from a small set of input-output examples. Perhaps the synthesizer is given a few pairs of lists of integers, and the user hopes that the synthesizer will produce a sorting function. Then useful properties might include functions that check if the input and output lists have the same length, if the input list is a subset of the output, if element 0 of the output list is less than element 42, and so on.

The outputs of a set of properties can be concatenated into a vector, yielding a representation that can be referred to as a property signature. Property signatures can then be used for consumption by machine learning algorithms, essentially serving as the first layer of a neural network. Property signatures can in some implementations be used for program synthesis, for example using them to perform a type of premise selection. More broadly, however, property signatures can be used across a broad range of problems, including algorithm induction, improving code readability, and program analysis.

Thus, one aspect of the present disclosure is directed to systems and methods which generate and/or use property signatures, which can be a general purpose way of featurizing both programs and program specifications. Another example aspect is directed to systems and methods that use property signatures within a machine-learning based synthesizer for a general-purpose programming language. This allows us to automatically learn a useful set of property signatures, rather than choosing them manually.

Another example aspect shows that a machine learning model can predict the signatures of individual functions given the signature of their composition and describes several ways this could be used to improve existing synthesizers. Another example aspect includes experiments on a new test set of 185 functional programs of varying difficulty, designed to be the sort of algorithmic problems that one would ask on an undergraduate computer science examination. These experiments demonstrated that the use of property signatures leads to a dramatic improvement in the performance of the synthesizer, allowing it to synthesize over twice as many programs in less than one-tenth of the time. Details regarding example experiments are contained in U.S. Provisional Patent App. No. 62/970,899.

One example program synthesized by the proposed system, reformatted and with variables renamed for readability, is as follows. This program returns the sub-list of all of the elements in a list that are distinct from their previous value in the list.

| | |
|---|---|
| 1 | fun unique_justseen(xs :List<Int>) -> List<Int> { |
| 2 | let triple = list_foldl_<Int, (List<Int>, Int, Bool)>( |
| 3 | xs, |
| 4 | (nil<Int>, 0, _1), |
| 5 | \(list_elt, (acc, last_elt, first)){ |
| 6 | cond_(or_(first, not_equal_(list_elt, last_elt)), |
| 7 | \{(cons_(list_elt, acc), list_elt, _0)}, |
| 8 | \{(acc, list_elt, _0)}) |
| 9 | }); |
| 10 | slist_reverse_(#0(triple)) |
| 11 | }; |

With reference now to the Figures, example embodiments of the present disclosure will be discussed in further detail.

### Example Programming by Example and Example Search Language

In Inductive Program Synthesis, a computing system is given a specification of a program and the goal is to synthesize a program meeting that specification. Inductive Synthesis is generally divided into Programming by Example (PBE) and Programming by Demonstration (PBD). In PBE, a computing system is given a set of input/output pairs such that for each pair, the target program takes the input to the corresponding output. A PBE specification might look like:

io_pairs=[(1,1),(2,4),(6,36),(10,100)]

for which a satisfying solution would be the function squaring its input. Arbitrarily many functions satisfy this specification.

Much (though not all) work on program synthesis is focused on domain specific languages that are less than maximally expressive. Example implementations of the present disclosure focus on the synthesis of programs in a Turing complete language. However, this presents technical challenges: First, general purpose languages such as C++ or Python are typically quite complicated and sometimes not fully specified; this makes it a challenge to search over partial programs in those languages. Second, sandboxing and executing code written in these languages is nontrivial. Finally, searching over and executing many programs in these languages can be quite slow, since this is not what they were designed for.

For these reasons, example implementations of the present disclosure provide and leverage general-purpose, Turing complete programming language and runtime. The programming language is called Searcho and it and its runtime have been designed specifically with program synthesis in mind. The language can roughly be thought of as a more complicated version of the simply typed lambda calculus or as a less complicated version of Standard ML or OCaml. Searcho code can be compiled to bytecode and run on the Searcho Virtual Machine. Code can be incrementally compiled, which means that the standard library and specification can be compiled once and then many programs can be pushed on and popped off from the stack in order to check them against the specification. Searcho is strongly typed with algebraic datatypes. Searcho includes a library of 86 functions, all of which are supported by the proposed synthesizer. This is a significantly larger language and library than have been used in previous work on neural program synthesis.

Some example implementations of the present disclosure also include a baseline enumerative synthesizer. Example experiments described in U.S. Provisional Patent App. No. 62/970,899 involve plugging the outputs of a machine learning model into the configuration for the baseline synthesizer to improve its performance on a set of human-constructed PBE tasks.

### Example Property Signatures

Consider the PBE specification that follows:

| | |
|---|---|
| 1 | io_pair = [ |
| 2 | ([1, 2345, 34567], [1, 2345, 34567, 34567, 2345, 1]), |
| 3 | ([True, False], [True, False, False, True]), |
| 4 | ([“Batman”], [“Batman”, “Batman”]), |
| 5 | ([[1,2,3], [4,5,6]], [[1,2,3], [4,5,6], [4,5,6], [1,2,3]]) |
| 6 | ]. |

In can be seen that the function concatenating the input list to its reverse will satisfy the specification, but how can this be taught to a computer? Example implementations of the present disclosure take the approach training a machine learning model to do premise selection for a symbolic search procedure. But how does a representation of the specification get fed to the model? As one example, the model may act only on integers and lists of integers, may constrain all integers to lie in [−256, 256], may have special-case handling of lists, and/or may not deal with polymorphic functions. It would be hard to apply this technique to the above specification, since the first example contains unbounded integers, the second example contains a different type than the first, and the third and fourth examples contain recursive data structures (lists of characters and lists of integers respectively).

To resolve this issue, some example implementations of the present disclosure can instead learn a representation that is composed of the outputs of multiple other programs running on each input/output pair. These other programs can be called properties. Consider the three properties shown below.

| | | |
|---|---|---|
| 1 | all_inputs_in_outputs | ins outs = all (map (\x -> x in outs) ins) |
| 2 | outputs_has_dups | ins outs = has_duplicates (outs) |
| 3 | input_same_len_as_output | ins outs = (len ins) == (len outs) |

Each of these three programs can be run on all 4 of the input output pairs to yield a Boolean. The first always returns True for our spec, as does the second. The third always returns False on the given examples, although note that it would return True if the examples had contained the implicit base case of the empty list. Thus, it can be written that the spec has the ‘property signature’ [True,True, False].

How is this useful? From the first property one can infer that one should not throw away any elements of the input list. From the third one might guess that one might have to add or remove elements from the input list. Finally, the second might imply that one might need to create copies of the input elements somehow. This does not narrow the search down all the way, but it narrows it down quite a lot. Since the properties are expressed in the same language as the programs that are being synthesized, an example system can emit them using the same synthesizer. Later on, it will be described how to enumerate many random properties and prune them to keep only the useful ones. The property signatures can in some examples contain thousands of values.

Since the output of these properties is either always True, always False, or sometimes True and sometimes False, a neural network can learn embeddings for those three values and it can be fed a vector of such values, one for each applicable property, as the representation of a program specification.

Example Abstracting Properties into Signatures

This section describes the representation for a program ƒ:: τᵢₙ→τₒᵤₜ. Each property is a program p:: (τᵢₙ, τₒᵤₜ)→Bool that represents a single “feature” of the program's inputs and outputs which might be useful for its representation. In this section, it is assumed that a sequence P=[p₁ . . . pₙ] of properties have been determined that are useful for describing ƒ, and we wish to combine them into a single representation of ƒ. Later sections will describe a learning principle for choosing relevant properties.

The property signature summarizes the output of all the properties in P over all valid inputs to ƒ. To do this, first extend the notion of property to a set of inputs in the natural way. If S is a set of values of type τᵢₙ and p∈P, define p(S)={p(x, ƒ(x))|x∈S}. Because p(S) is a set of booleans, it can have only three possible values, either p(S)={True}, or p(S)={False}, or p(S)={True, False}, corresponding respectively to the cases where p is always true, always false, or neither.

To simplify notation slightly, define the function Π as Π({True})=AllTrue, Π({False})=AllFalse, and Π({True, False})=Mixed. Finally, define the property signature sig(P,ƒ) for a program ƒ and a property sequence P as

sig(P,ƒ)[i]=Π(pᵢ(V(τᵢₙ))),

where V (τᵢₙ) is the possibly infinite set of all values of type xii.

Computing the property signature for ƒ could be intractable or undecidable, as it might require proving difficult facts about the program. Instead, in practice, some example implementations can compute an estimated property signature for a small set of input-output pairs Sᵢₒ. The estimated property signature summarizes the actions of P on Sᵢₒ rather than on the full set of inputs V (τin). Formally, the estimated property signature is

[symbol]

(P,Sᵢₒ)[i]:Π({pᵢ(xᵢₙ,xₒᵤₜ)|(xᵢₙ,xₒᵤₜ)∈Sᵢₒ}) (1)

This estimate gives us under-approximation of the true signature of ƒ in the following sense: If we have [symbol] (P,S)=Mixed, we must also have sig (P,ƒ)=Mixed. If [symbol] (P,S)=AllTrue, then either s sig(P,ƒ)=AllTrue or sig(P,ƒ)=Mixed, and similarly with AllFalse.

Estimated property signatures are particularly useful for synthesis using PBE, because a computing system can compute them from the input-output pairs that specify the synthesis task, without having the definition of ƒ. Thus, a computing system can use estimated property signatures to ‘featurize’ PBE specifications for use in synthesis.

Example Techniques for Learning Useful Properties

How should one choose a set of properties that will be useful for synthesis? Given a training set of random programs with random input/output examples, many random properties can be generated. Random properties can then be pruned based on whether they distinguish between any of the programs. Then, given a test suite of programs, an additional pruning step can be performed as follows: among all properties that give the same value for every element of the test suite, keep the shortest property, because of Occam's razor considerations.

Given these ‘useful’ properties, a computing system can train a premise selector to predict library function usage given properties. Specifically, from the remaining properties, a computing system can compute estimated property signatures for each function in the training set, based on its input output examples.

Then a computing system can use the property signature as the input to a feedforward network that predicts the number of times each library function appears in the program. Other portions of this disclosure give more details about the architecture of this premise selector and evaluate it for synthesis. For now, note that this premise selector could itself be used to find useful properties, by examining which properties are most useful for the model's predictions.

Example Uses of Property Signatures

Experiments in the next section will establish that property signatures let a baseline synthesizer emit programs it previously could not, but the property signatures also have broader utility as follows:

They allow a computing system represent more types of functions. Property signatures can automatically deal with unbounded data types, recursive data types, and polymorphic functions.

They reduce dependency on the distribution from which examples are drawn. If the user of a synthesizer gives example inputs distributed differently than the training data, the ‘estimated’ properties might not change much.

They can be used wherever wanted to search for functions by semantics. Imagine a search engine where users give a specification, the system guesses a property signature, and this signature guess is used to find all the pre-computed functions with similar semantics.

Synthesized programs can themselves become new properties. For example, once a program is learned for primality checking, primality checking can be used in a library of properties

### Example Program Synthesis with Property Signatures

This section describes an example experiment which demonstrates that property signatures can help synthesize programs that otherwise could not have synthesized.

Example Experimental Setup

How Does the Baseline Synthesizer Work?

One example baseline synthesizer works by filling in typed holes. In the synthesis literature, this approach of first discovering the high-level structure and then filling it in is sometimes called ‘top-down’ synthesis. Top-down synthesis is to be contrasted with ‘bottom-up’ synthesis, in which low-level components are incrementally combined into larger programs.

That is, a computing system can infer a program type τᵢₙ→τₒᵤₜ from the specification and the synthesizer can start with an empty ‘hole’ of type τᵢₙ→τₒᵤₜ and then fill it in all possible ways allowed by the type system. Many of these ways of filling-in will yield new holes, which can in turn be filled by the same technique. When a program has no holes, a computing system can check if it satisfies the spec. A computing system can order the programs to expand by their cost, where the cost is essentially a sum of the costs of the individual operations used in the program.

At the beginning of the procedure, the synthesizer can be given a configuration, which is essentially a weighted set of pool elements that it is allowed to use to fill in the holes. A pool element is a rewrite rule that replaces a hole with a type-correct Searcho program, which may itself contain its own, new holes. In some example synthesizers, there is one possible pool element for each of the 86 library functions in Searcho, which calls the library function, with correctly-typed holes for each of its arguments. The configuration will specify a small subset of these pool elements to use during search. It is through the configuration that a computing system can use machine learning to inform the search procedure.

How is the Training Data Generated?

An example test corpus contains programs with 14 different types. For each of those 14 types, a computing system can randomly sample configurations and then randomly generate training programs for each configuration, pruning for observational equivalence. A computing system can generate up 10,000 semantically distinct programs for each type, though of course some function types admit less distinct programs than this (e.g. Bool→Bool). A computing system can also generate and prune random properties. Here are some example useful properties that were generated:

| | |
|---|---|
| 1 | \:(List<Int>, List<Int>)->Bool (input, output) { |
| 2 | list_for_all_<Int> (input, \x {in_list_<Int> (x, output)})} |
| 3 | \:(List<Int>, List<Int>)->Bool (input, output) { |
| 4 | not_ (is_even_ (list_len_<Int> output))} |
| 5 | \:(List<Int>, List<Int>)->Bool (input, output) { |
| 6 | not_equal_<Int> ((ints_sum_ input), (ints_sum_ output))} |
| 7 | \:(List<Int>, List<Int>)->Bool (input, output) { |
| 8 | gt_ ((list_len_<Int> input), (list_len_<Int> output))} |

These are four of the Properties with the highest discriminative power on functions of type List<Int>→List<Int>. The first checks if every element of the input list is in the output list. The second checks if the length of the output list is even. The third checks if sum of the input and the output list is the same, and the fourth checks if the input list is longer than the output list.

How was the Test Set Constructed?

An example test set was used which included 185 human generated programs ranging in complexity from one single line to many nested function calls with recursion. Programs in the test set include computing the GCD of two integers, computing the n-th fibonacci number, computing the intersection of two sets, and computing the sum of all pairs in two lists. None of the test functions appear in the training set.

What is the Architecture of the Model?

As mentioned above, a computing system can train a neural network to predict the number of times each pool element will appear in the output. This neural network is fully connected, with learned embeddings for each of the values AllTrue, AllFalse and Mixed.

How does the Model Output Inform the Search Procedure?

Since there are a large number of pool elements (86), the synthesizer was not run with all pool elements so as to find programs of reasonable length. This is both because a computing system can may run out of memory and because it may take too long. Thus, a computing system can randomly sample configurations with less pool elements. A computing system can then send multiple such configurations to a distributed synthesis server that tries them in parallel.

When a computing system uses the model predictions, a computing system can sample pool elements in proportion to the model's predicted number of times that pool element appears. The baseline can sample pool elements in proportion to their rate of appearance in the training set.

Using Property Signatures Lets a Computing System Synthesize New Functions

A computing system ran 3 different runs of the described distributed synthesizer for 100,000 seconds with and without the aid of property signatures. The baseline synthesizer solved 28 test programs on average. With property signatures, the synthesizer solved an average of 73 test programs. Not only did the synthesizer solve many more test programs using property signatures, but it did so much faster, synthesizing over twice as many programs in one-tenth of the time as the baseline.

### Example Techniques for Predicting Property Signatures of Function Compositions

Most programs involve composing functions with other functions. Suppose that we are trying to solve a synthesis problem from a set of input/output examples, and during the search we create a partial program of the form ƒ(g(x)) for some unknown g. Since we know ƒ, we know its property signature. Since we have the program specification, we also have the estimated property signature for ƒ∘g: =ƒ(g(x)). If we could somehow guess the signature for g, we could look it up in a cache of previously computed functions keyed by signature. If we found a function matching the desired signature, we would be done. If no matching function exists in the cache, we could start a smaller search with only the signature of g as the target, then use that result in our original search. We could attempt to encode the relationship between ƒ and g into a set of formal constraints and pass that to a solver of some kind, and while that is potentially an effective approach, it may be difficult to scale to a language like Searcho. Instead, a computing system can simply train a machine learning model to predict the signature of g from the signature of ƒ and the signature of ƒ∘g.

This section presents an experiment to establish a proof of concept of this idea. First, a data set of 10,000 random functions was generated taking lists of integers to lists of integers. Then a computing system randomly chose 50,000 pairs of functions from this list, arbitrarily designating one as ƒ and one as g. A computing system then computed the signatures of ƒ, g and ƒ∘g for each pair, divided the data into a training set of 45,000 elements and a test set of 5,000 elements, and trained a small fully connected neural network to predict the signature of g from the other two signatures.

On the test set, this model had 87.5% accuracy, which is substantially better than chance. An inspection of the predictions made on the test set returned interesting examples like the one provided below, where the model has learned to do something that might (cautiously) be referred to as logical deduction on properties. This result is suggestive of the expressive power of property signatures. It also points toward exciting future directions for research into neurally guided program synthesis.

| | |
|---|---|
| 1 | f: \:List<Int>->List<Int> inputs { |
| 2 | consume_ (inputs, (list_foldl_<Int, Int> (inputs, int_min, mod_)))} |
| 3 | g: \:List<Int>->List<Int> inputs { |
| 4 | list_map_<Int, Int> (inputs, neg_)} |
| 5 | prop: \:(List<Int>, List<Int>)->Bool (inputs, outputs) { |
| 6 | list_for_all_<Int> (outputs, \x {in_list_<Int> (x, inputs)})} |

This listing shows an example of successful prediction made by our composition predictor model. The property in question checks whether all the elements of the output list are members of the input list. For ƒ, the value is AllTrue, and for ƒ∘g the value is Mixed. The model doesn't know g or its signature, but correctly predicts that the value of this property for g must be Mixed.

### Example Techniques for Building a Search Engine for Functions

Starting with a database of functions that one would like to be able to search, a computing system can generate a set of random input-output pairs and compute the property signature for each function in the database. These property signatures can be referred to as the ‘index signatures’. A computing system can then build an approximate-nearest-neighbors index of the database using these index signatures. In some example implementations, a computing system can use a Ball Tree. When a user wants to search for a program with particular semantics, they simply write down some input-output pairs specifying those semantics. A ‘query signature’ is computed from those input-output pairs. A computing system can then perform approximate nearest neighbors lookup of the query signature in the index signatures, returning some number of nearest neighbors and, optionally, checking those neighbors against the user-provided input-output pairs.

First, a computing system can build the index. A query is specified by a user giving a list of input-output pairs. In order to convert that list to a property signature that a computing system can search, a computing system can run each of the property functions on the input-output pairs given by the user. A computing system can count each evaluation of a property on a full set of input-output pairs (we use 5 for these experiments) as one ‘function invocation’ for simplicity's sake. Thus, there is one function invocation charged to the query per property in the property signature.

Once the property signature is computed, a computing system can do a nearest neighbor search using the query signature and the data structure of index signatures. Modern approximate nearest neighbor techniques are sufficiently fast that this part can be ignored for evaluation of computational speed, but to be safe we count it as one extra function invocation.

Finally, when a computing system has retrieved the list of k neighbors that will be treated as candidate programs, a computing system may have to check each of these candidate programs against the user specification. This can be counted as one function invocation per candidate without any issue, since a computing system can just run the program on the same input-output pairs that are used to compute the properties. Thus, the cost in terms of function invocations of one example proposed search engine is simply the number of properties used in property signatures plus the number of neighbors returned, plus one. Note that this analysis is pessimistic for at least two reasons: First, properties will tend to be shorter than programs in the index and so will likely be faster to run in general. Second, we don't actually have to run each neighbor against every input-output pair, we only have to run it until it gets one of the pairs wrong.

In practice, that could mean that each additional neighbor is closer to one fifth (or some other number, depending on how many input-output pairs there are) the cost of each additional property.

The technique described above is one example technique that works reasonably well, but other potential techniques can be used as well. One example technique trains a model using a triplet loss (Hoffer & Ailon, 2015) to take a set of input-output pairs to an ‘embedding’ such that embeddings were the same for sets of input-output pairs implying the same function.

### Example Devices and Systems

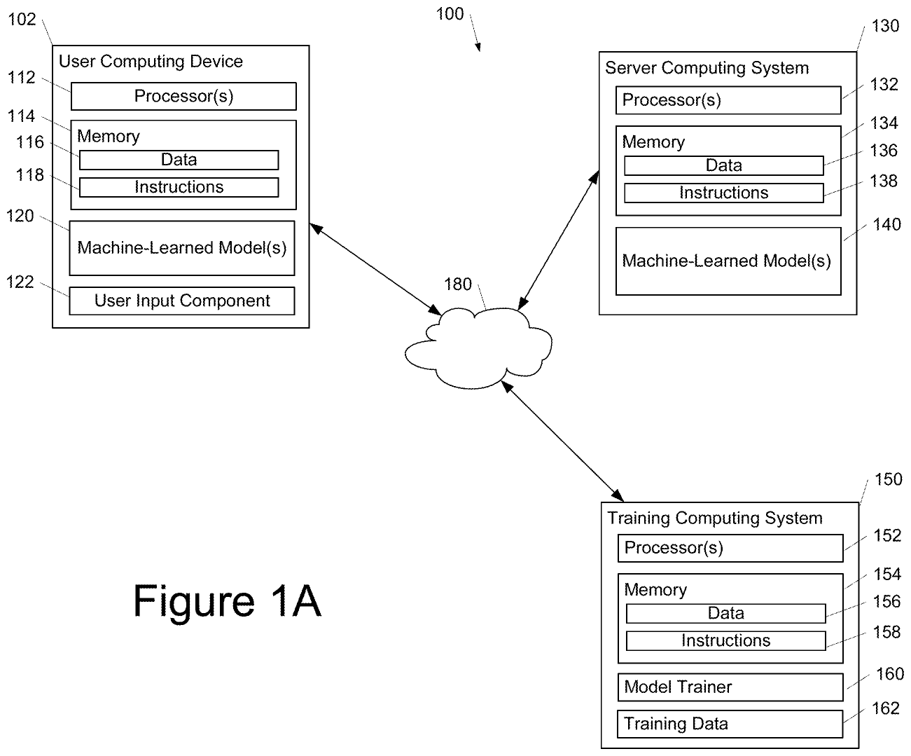

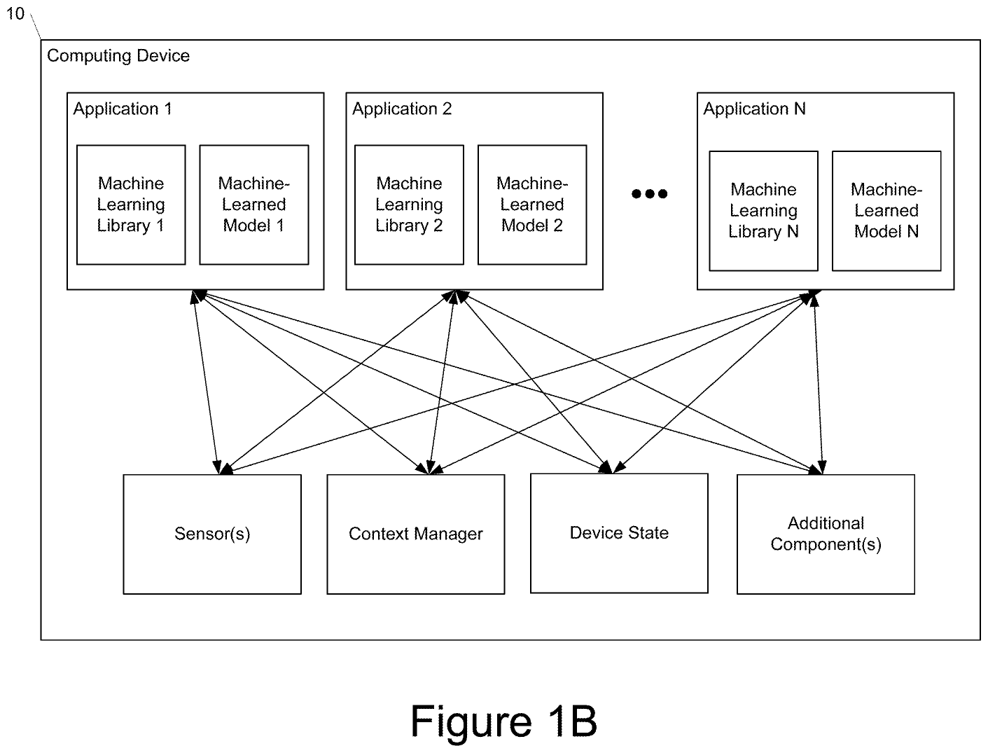

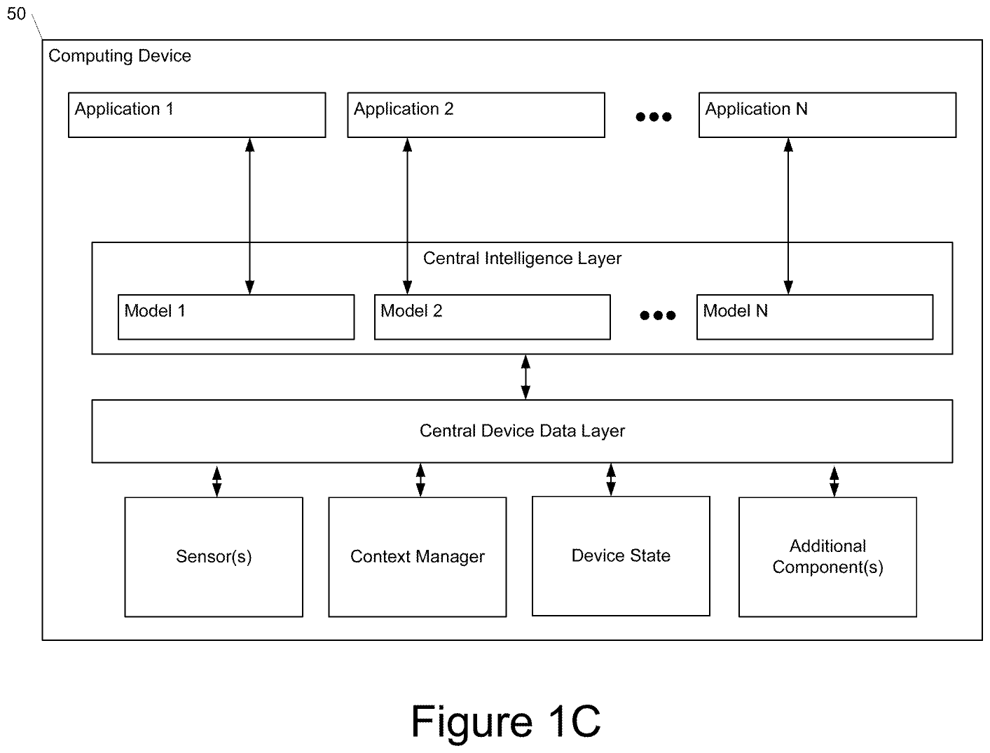

FIG. 1A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel computer program analysis, synthesis, and/or search).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

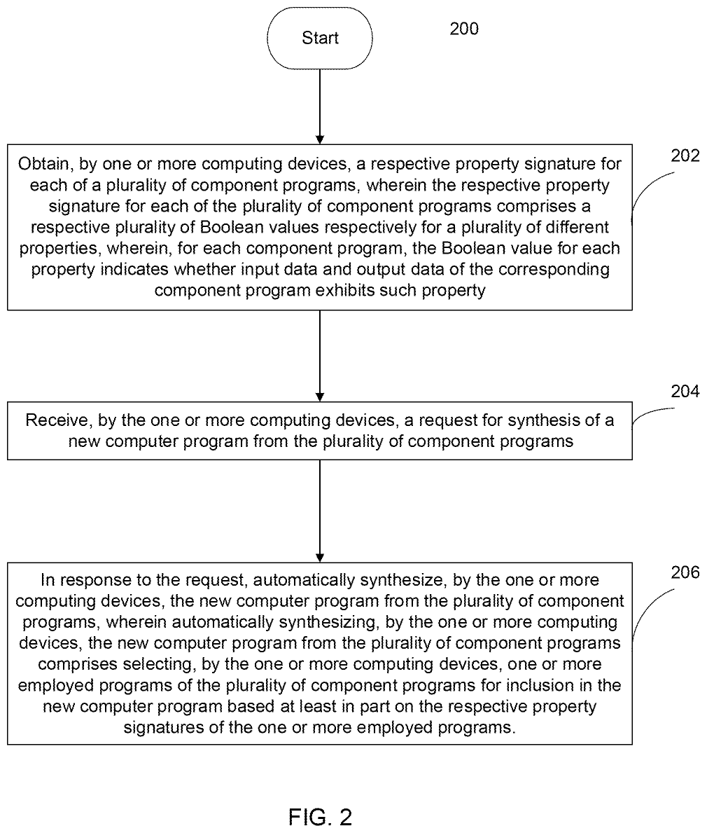

FIG. 2 provides a flow chart for an example computer-implemented method 200 for automated synthesis of computer programs.

The computer-implemented method 200 includes at 202 obtaining, by one or more computing devices, a respective property signature for each of a plurality of component programs, where the respective property signature for each of the plurality of component programs may include a respective plurality of Boolean values respectively for a plurality of different properties, where, for each component program, the Boolean value for each property indicates whether input data and output data of the corresponding component program exhibits such property.

The method 200 also includes at 204 receiving, by the one or more computing devices, a request for synthesis of a new computer program from the plurality of component programs.

The method 200 also includes at 206 in response to the request, automatically synthesizing, by the one or more computing devices, the new computer program from the plurality of component programs, where automatically synthesizing, by the one or more computing devices, the new computer program from the plurality of component programs may include selecting, by the one or more computing devices, one or more employed programs of the plurality of component programs for inclusion in the new computer program based at least in part on the respective property signatures of the one or more employed programs.

Other embodiments of this aspect include corresponding computer systems, apparatus, and computer programs recorded on one or more computer storage devices, each configured to perform the actions of the methods.

Example implementations may include one or more of the following features. The computer-implemented method where obtaining, by the one or more computing devices, the respective property signature for each of the plurality of component programs may include generating, by the one or more computing devices, the respective property signature for each of the plurality of component programs.

Generating, by the one or more computing devices, the respective property signature for each of the plurality of component programs may include, for each of the plurality of component programs: supplying, by the one or more computing devices, one or more sets of evaluative inputs to the component program; receiving, by the one or more computing devices, one or more sets of evaluative outputs from the component program in response to the one or more sets of evaluative inputs; and for each of the plurality of properties: determining, by the one or more computing devices, whether the one or more sets of evaluative inputs and the one or more sets of evaluative outputs exhibit the property; and generating, by the one or more computing devices, the corresponding Boolean value based on whether the one or more sets of evaluative inputs and the one or more sets of evaluative outputs exhibit the property.

The one or more sets of evaluative inputs and the one or more sets of evaluative outputs may include example input-output pairs that specify a synthesis task associated with the request for synthesis of a new computer program from the plurality of component programs.

The computer-implemented method 200 may include: selecting, by the one or more computing devices, the plurality of properties from a plurality of candidate properties.

Selecting, by the one or more computing devices, the plurality of properties from the plurality of candidate properties may include: obtaining, by the one or more computing devices, a plurality of training programs; evaluating, by the one or more computing devices, each of the plurality of candidate properties for each of the plurality of training programs; and pruning, by the one or more computing devices, at least one candidate property for which all training programs provide a same evaluative result.

The request for synthesis of the new computer program may include a programming by example request that specifies a set of example input-output pairs.

Each of the plurality of component programs may include a set of instructions encoded within a computer-readable format.

Selecting, by the one or more computing devices, the one or more employed programs of the plurality of component programs for inclusion in the new computer program based at least in part on the respective property signatures of the one or more employed programs may include iteratively selecting, by the one or more computing devices, the one or more employed programs based on a current hole type associated with the new computer program.

Selecting, by the one or more computing devices, the one or more employed programs of the plurality of component programs for inclusion in the new computer program based at least in part on the respective property signatures of the one or more employed programs may include: processing, by the one or more computing devices, the respective property signatures of the plurality of component programs with a machine-learned model to receive a respective predicted likelihood of usage of each component program as an output of the machine-learned model; and selecting, by the one or more computing devices, the one or more employed programs of the plurality of component programs for inclusion in the new computer program based at least in part on the respective predicted likelihood of usage of the one or more employed programs.

Selecting, by the one or more computing devices, the one or more employed programs of the plurality of component programs for inclusion in the new computer program based at least in part on the respective property signatures of the one or more employed programs may include: determining, by the one or more computing devices, a desired property signature associated with the new computer program; and for each of one or more of the plurality of component programs; providing, by the one or more computing devices, the desired property signature of the new computer program and the property signature of the component program as input to a machine-learned model; and receiving, by the one or more computing devices, a signature prediction as an output of the machine-learned model, where the signature prediction may include a predicted signature for an unidentified component program that, when combined with the property signature of the component program, would result in the desired property signature of the new computer program; and searching, by the one or more computing devices, the plurality of component programs to identify any component programs with the predicted signature.

The unidentified component program can be used as a function of the component program.

Implementations of the described techniques may include hardware, a method or process, or computer software on a computer-accessible medium.

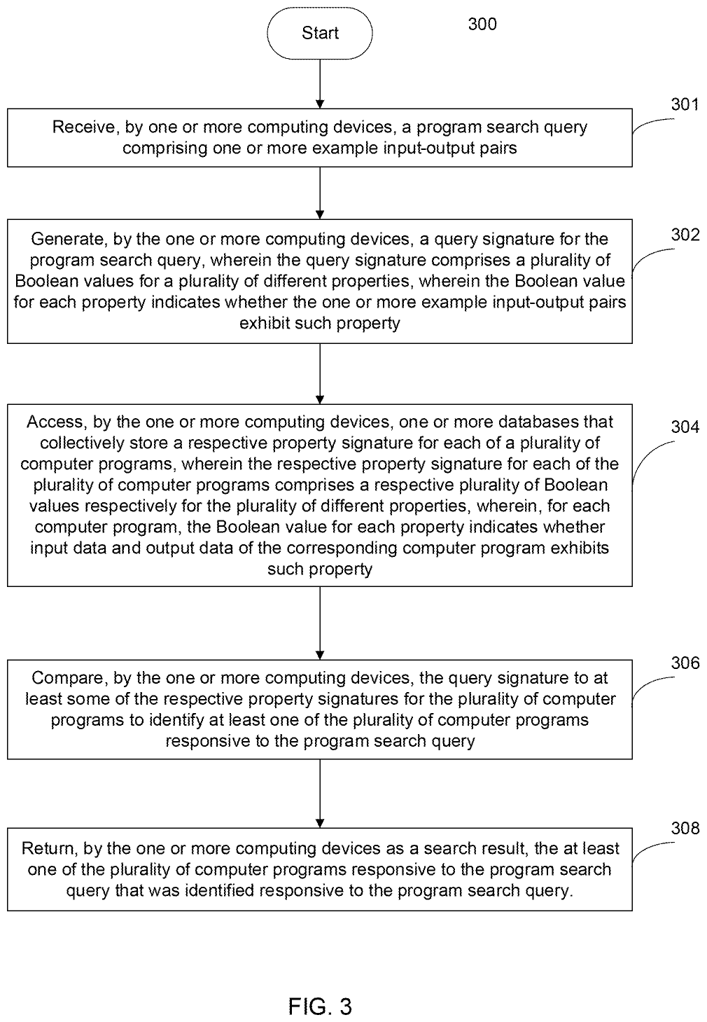

FIG. 3 depicts a flow chart of an example computer-implemented method 300 to search for computer programs.

The computer-implemented method 300 includes at 301 receiving, by one or more computing devices, a program search query may include one or more example input-output pairs.

The method 300 also includes at 302 generating, by the one or more computing devices, a query signature for the program search query, where the query signature may include a plurality of Boolean values for a plurality of different properties, where the Boolean value for each property indicates whether the one or more example input-output pairs exhibit such property.

The method 300 also includes at 304 accessing, by the one or more computing devices, one or more databases that collectively store a respective property signature for each of a plurality of computer programs, where the respective property signature for each of the plurality of computer programs may include a respective plurality of Boolean values respectively for the plurality of different properties, where, for each computer program, the Boolean value for each property indicates whether input data and output data of the corresponding computer program exhibits such property.

The method 300 also includes at 306 comparing, by the one or more computing devices, the query signature to at least some of the respective property signatures for the plurality of computer programs to identify at least one of the plurality of computer programs responsive to the program search query.

The method 300 also includes at 308 returning, by the one or more computing devices as a search result, the at least one of the plurality of computer programs responsive to the program search query that was identified responsive to the program search query. Other embodiments of this aspect include corresponding computer systems, apparatus, and computer programs recorded on one or more computer storage devices, each configured to perform the actions of the methods.

Example implementations may include one or more of the following features.

Comparing, by the one or more computing devices, the query signature to at least some of the respective property signatures for the plurality of computer programs may include performing, by the one or more computing devices, an approximate nearest neighbor search for the query signature relative to the respective property signatures for the plurality of computer programs stored in the one or more databases.

The computer-implemented method may include, for each computer program returned as a search result: inputting, by the one or more computing devices, each example input of the example input-output pairs into the computer program to obtain result-generated outputs; and comparing, by the one or more computing devices, the result-generated outputs with the example outputs of the example input-output pairs.

The respective property signatures of the plurality of computer programs may be structured in the one or more databases as a ball tree nearest-neighbor library.

The computer-implemented method may include: selecting, by the one or more computing devices, the plurality of properties from a plurality of candidate properties based at least in part on which of the plurality of candidate properties exhibit a smallest amount of distortion between a validation dataset and an index dataset.

Generating, by the one or more computing devices, the respective property signature for each of the plurality of computer programs may include, for each of the plurality of computer programs: supplying, by the one or more computing devices, one or more sets of evaluative inputs to the computer program; receiving, by the one or more computing devices, one or more sets of evaluative outputs from the computer program in response to the one or more sets of evaluative inputs; and for each of the plurality of properties: determining, by the one or more computing devices, whether the one or more sets of evaluative inputs and the one or more sets of evaluative outputs exhibit the property; and generating, by the one or more computing devices, the corresponding Boolean value based on whether the one or more sets of evaluative inputs and the one or more sets of evaluative outputs exhibit the property.

The one or more sets of evaluative inputs and the one or more sets of evaluative outputs may include of the example input-output pairs included in the program search query.

Implementations of the described techniques may include hardware, a method or process, or computer software on a computer-accessible medium.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for automated synthesis of computer programs, the method comprising:
obtaining, by one or more computing devices, a respective property signature for each of a plurality of component programs, wherein the respective property signature for each of the plurality of component programs comprises a respective plurality of Boolean values respectively for a plurality of different properties, wherein, for each component program, the Boolean value for each property indicates whether input data and output data of the corresponding component program exhibits such property;
receiving, by the one or more computing devices, a request for synthesis of a new computer program from the plurality of component programs; and
in response to the request, automatically synthesizing, by the one or more computing devices, the new computer program from the plurality of component programs, wherein automatically synthesizing, by the one or more computing devices, the new computer program from the plurality of component programs comprises selecting, by the one or more computing devices, one or more employed programs of the plurality of component programs for inclusion in the new computer program based at least in part on the respective property signatures of the one or more employed programs.

2. The computer-implemented method of claim 1, wherein obtaining, by the one or more computing devices, the respective property signature for each of the plurality of component programs comprises generating, by the one or more computing devices, the respective property signature for each of the plurality of component programs.

3. The computer-implemented method of claim 2, wherein generating, by the one or more computing devices, the respective property signature for each of the plurality of component programs comprises, for each of the plurality of component programs:
supplying, by the one or more computing devices, one or more sets of evaluative inputs to the component program;
receiving, by the one or more computing devices, one or more sets of evaluative outputs from the component program in response to the one or more sets of evaluative inputs; and
for each of the plurality of properties:
determining, by the one or more computing devices, whether the one or more sets of evaluative inputs and the one or more sets of evaluative outputs exhibit the property; and
generating, by the one or more computing devices, the corresponding Boolean value based on whether the one or more sets of evaluative inputs and the one or more sets of evaluative outputs exhibit the property.

4. The computer-implemented method of claim 3, wherein the one or more sets of evaluative inputs and the one or more sets of evaluative outputs consist of example input-output pairs that specify a synthesis task associated with the request for synthesis of a new computer program from the plurality of component programs.

5. The computer-implemented method of claim 1, further comprising:
selecting, by the one or more computing devices, the plurality of properties from a plurality of candidate properties.

6. The computer-implemented method of claim 5, wherein selecting, by the one or more computing devices, the plurality of properties from the plurality of candidate properties comprises:
obtaining, by the one or more computing devices, a plurality of training programs;
evaluating, by the one or more computing devices, each of the plurality of candidate properties for each of the plurality of training programs; and
pruning, by the one or more computing devices, at least one candidate property for which all training programs provide a same evaluative result.

7. The computer-implemented method of claim 1, wherein the request for synthesis of the new computer program comprises a programming by example request that specifies a set of example input-output pairs.

8. The computer-implemented method of claim 1, wherein each of the plurality of component programs comprises a set of instructions encoded within a computer-readable format.

9. The computer-implemented method of claim 1, wherein selecting, by the one or more computing devices, the one or more employed programs of the plurality of component programs for inclusion in the new computer program based at least in part on the respective property signatures of the one or more employed programs comprises iteratively selecting, by the one or more computing devices, the one or more employed programs based on a current hole type associated with the new computer program.

10. The computer-implemented method of claim 1, wherein selecting, by the one or more computing devices, the one or more employed programs of the plurality of component programs for inclusion in the new computer program based at least in part on the respective property signatures of the one or more employed programs comprises:
processing, by the one or more computing devices, the respective property signatures of the plurality of component programs with a machine-learned model to receive a respective predicted likelihood of usage of each component program as an output of the machine-learned model; and
selecting, by the one or more computing devices, the one or more employed programs of the plurality of component programs for inclusion in the new computer program based at least in part on the respective predicted likelihood of usage of the one or more employed programs.

11. The computer-implemented method of claim 1, wherein selecting, by the one or more computing devices, the one or more employed programs of the plurality of component programs for inclusion in the new computer program based at least in part on the respective property signatures of the one or more employed programs comprises:
determining, by the one or more computing devices, a desired property signature associated with the new computer program; and
for each of one or more of the plurality of component programs;
providing, by the one or more computing devices, the desired property signature of the new computer program and the property signature of the component program as input to a machine-learned model; and
receiving, by the one or more computing devices, a signature prediction as an output of the machine-learned model, wherein the signature prediction comprises a predicted signature for an unidentified component program that, when combined with the property signature of the component program, would result in the desired property signature of the new computer program; and
searching, by the one or more computing devices, the plurality of component programs to identify any component programs with the predicted signature.

12. The computer-implemented method of claim 11, wherein the unidentified component program is used as a function of the component program.

13. A computing system for characterization of computer programs, the computing system comprising:
one or more processors;
one or more non-transitory computer-readable media that store instructions that, when executed by the one or more processors, cause the computing system to perform operations, the operations comprising:
obtaining data describing a plurality of component programs; and
generating a respective property signature for each of the plurality of component programs, wherein the respective property signature for each of the plurality of component programs comprises a respective plurality of Boolean values respectively for a plurality of different properties, wherein, for each component program, the Boolean value for each property indicates whether input data and output data of the corresponding component program exhibits such property.

14. A computer-implemented method to search for computer programs, the method comprising:
receiving, by one or more computing devices, a program search query comprising one or more example input-output pairs;
generating, by the one or more computing devices, a query signature for the program search query, wherein the query signature comprises a plurality of Boolean values for a plurality of different properties, wherein the Boolean value for each property indicates whether the one or more example input-output pairs exhibit such property;
accessing, by the one or more computing devices, one or more databases that collectively store a respective property signature for each of a plurality of computer programs, wherein the respective property signature for each of the plurality of computer programs comprises a respective plurality of Boolean values respectively for the plurality of different properties, wherein, for each computer program, the Boolean value for each property indicates whether input data and output data of the corresponding computer program exhibits such property;
comparing, by the one or more computing devices, the query signature to at least some of the respective property signatures for the plurality of computer programs to identify at least one of the plurality of computer programs responsive to the program search query; and
returning, by the one or more computing devices as a search result, the at least one of the plurality of computer programs responsive to the program search query that was identified responsive to the program search query.

15. The computer-implemented method of claim 14, wherein comparing, by the one or more computing devices, the query signature to at least some of the respective property signatures for the plurality of computer programs comprises performing, by the one or more computing devices, an approximate nearest neighbor search for the query signature relative to the respective property signatures for the plurality of computer programs stored in the one or more databases.

16. The computer-implemented method of claim 14, further comprising, for each computer program returned as a search result:
inputting, by the one or more computing devices, each example input of the example input-output pairs into the computer program to obtain result-generated outputs; and
comparing, by the one or more computing devices, the result-generated outputs with the example outputs of the example input-output pairs.

17. The computer-implemented method of claim 14, wherein the respective property signatures of the plurality of computer programs are structured in the one or more databases as a Ball Tree nearest-neighbor library.

18. The computer-implemented method of claim 14, further comprising:
selecting, by the one or more computing devices, the plurality of properties from a plurality of candidate properties based at least in part on which of the plurality of candidate properties exhibit a smallest amount of distortion between a validation dataset and an index dataset.

19. The computer-implemented method of claim 14, further comprising:
generating, by the one or more computing devices, the respective property signature for each of the plurality of computer programs, wherein generating, by the one or more computing devices, the respective property signature for each of the plurality of computer programs comprises, for each of the plurality of computer programs:
supplying, by the one or more computing devices, one or more sets of evaluative inputs to the computer program;
receiving, by the one or more computing devices, one or more sets of evaluative outputs from the computer program in response to the one or more sets of evaluative inputs; and
for each of the plurality of properties:
determining, by the one or more computing devices, whether the one or more sets of evaluative inputs and the one or more sets of evaluative outputs exhibit the property; and
generating, by the one or more computing devices, the corresponding Boolean value based on whether the one or more sets of evaluative inputs and the one or more sets of evaluative outputs exhibit the property.

20. The computer-implemented method of claim 19, wherein the one or more sets of evaluative inputs and the one or more sets of evaluative outputs consist of the example input-output pairs included in the program search query.
